(19) United States
(12) Patent Application Publication
(10) Pub. No.: US 2015/0013754 A1
(43) Pub. Date: Jan. 15, 2015

(54) SOLAR CELL MODULE MOUNTING STRUCTURE, SOLAR CELL MODULE MOUNTING METHOD, SOLAR CELL MODULE MOUNTING BEAM, AND SOLAR PHOTOVOLTAIC POWER GENERATING SYSTEM

(71) Applicant: SHARP KABUSHIKI KAISHA, Osaka-shi, Osaka (JP)

(72) Inventors: Tsuguharu Yakushiji, Osaka-shi (JP); Tetsuya Oshikawa, Osaka-shi (JP)

(21) Appl. No.: 14/374,410

(22) PCT Filed: Dec. 25, 2012
(86) PCT No.: PCT/JP2012/083468

§ 371 Date: Jul. 24, 2014

(30) Foreign Application Priority Data
Feb. 2, 2012 (JP) 2012-021193

(51) Int. Cl. H01L 31/042; F16M 13/02; H01L 31/18

(52) U.S. Cl. CPC H01L 31/0422; H01L 31/18; F16M 13/02
USPC 136/251; 29/825; 248/304

(57) ABSTRACT

A solar cell module mounting structure of the present invention includes a beam 4 that is disposed along an end of a solar cell module 5. The beam 4 has a first base portion 4d on which the end of the solar cell module 5 is placed, a standing portion 4a that stands with respect to the first base portion 4d, and a first hook portion 4b that is bent at an upper end of the standing portion 4a and engages with the end of the solar cell module 5. A first recess 4i that extends along a longitudinal direction of the beam 4 is formed in a part on an upper surface of the first base portion 4d that is separated from the standing portion 4a.

### TECHNICAL FIELD

The present invention relates to a solar cell module mounting structure, a solar cell module mounting method, a solar cell module mounting beam, and a solar photovoltaic power generating system for attaching and fixing a solar cell module.

### BACKGROUND ART

For example, PTL 1 describes a configuration in which a plurality of lateral beams are arranged in parallel and fixed, metal fastenings are attached to the respective lateral beams, solar cell modules are laid over the lateral beams, and ends of the solar cell modules are fixed to the lateral beams by the respective metal fastenings.

### CITATION LIST

### Patent Literature

PTL 1: Japanese Unexamined Patent Application Publication No. 2011-153465

### SUMMARY OF INVENTION

### Technical Problem

However, according to PTL 1, the lateral beams and the metal fastenings for fixing the ends of the solar cell modules to the lateral beams are used. Thus, the lateral beams, metal fastenings, and bolts, screws, and the like for fixing the lateral beams and the metal fastenings are needed, which results in the large number of parts and complicated assembling work of a support structure.

Further, because work for grounding the solar cell modules is separately performed after the solar cell modules are laid over and fixed to the lateral beams, the grounding work is also troublesome.

Accordingly, the present invention has been made in consideration of such problems of a conventional technology, and an object is to provide a solar cell module mounting structure, a solar cell module mounting method, a solar cell module mounting beam, and a solar photovoltaic power generating system that enables reduction in the numbers of parts and assembling steps.

### Solution to Problem

To solve the problems, a solar cell module mounting structure of the present invention includes a beam that is disposed along an end of the solar cell module, in which the beam has a first base portion on which the end of the solar cell module is placed, a standing portion that stands with respect to the first base portion, and a first hook portion that is bent at an upper end of the standing portion and engages with the end of the solar cell module, and a first recess that extends along a longitudinal direction of the beam is formed in a part on an upper surface of the first base portion that is separated from the standing portion.

In such a solar cell module mounting structure of the present invention, the first base portion, the standing portion, the first hook portion, and the first recess on the upper surface of the first base portion are provided in the beam itself. In a case where such a beam is used, the end of each solar cell module is able to be fixed to and supported by the beam by: disposing the end of the solar cell module in the first recess, inclining the beam with respect to a mounting surface of the beam to make the first hook portion approach the end of the solar cell module, raising the inclined beam, stably placing the beam on the mounting surface, sliding the end of the solar cell module from the first recess toward the standing portion on the first base portion, engaging the end of the solar cell module with the first hook portion, holding the end of the solar cell module between the first hook portion and the first base portion, and thereafter fixing the beam. Accordingly, the end of the solar cell module is fixed only by the beam, and it is not necessary to provide a separate metal fastening for fixing the end of the solar cell module on the beam, resulting in the small numbers of parts and assembling steps.

On the other hand, because a conventional technology employs a procedure in which the beam is fixed and the end of the solar cell module is thereafter fixed to the beam, the metal fastening for fixing the end of the solar cell module to the beam is necessary, resulting in the large numbers of parts and assembling steps compared to the present invention.

That is, the solar cell module mounting structure of the present invention is created in association with a particular procedure in which the end of the solar cell module is engaged with the beam and the beam is thereafter fixed.

Further, in the solar cell module mounting structure of the present invention, a cross-sectional shape of the first recess may be an inverted triangle.

In a case where the cross-sectional shape of the first recess is formed in an inverted triangle as described above, the end of the solar cell module is able to be placed stably on one side of the inverted triangle, and the end of the solar cell module may easily be slid from the first recess toward the standing portion.

In addition, in the solar cell module mounting structure of the present invention, an engagement portion that engages with the first hook portion may be provided at the end of the solar cell module.

Accordingly, the beam is able to be engaged securely with the end of the solar cell module.

Further, in the solar cell module mounting structure of the present invention, the beam preferably has a second base portion that is provided on an opposite side from the first base portion with respect to the standing portion and on which an end of the solar cell module is placed and a second hook portion that is bent to an opposite side from the first hook portion at the upper end of the standing portion and engages with the end of the solar cell module, and a second recess that extends along the longitudinal direction of the beam is preferably formed in a part on an upper surface of the second base portion that is separated from the standing portion.

In this case, the two solar cell modules are able to be fixed next to each other across the standing portion.

Next, a solar cell module mounting structure of the present invention is a solar cell module mounting structure that couples and supports a plurality of arrayed solar cell modules, which includes a beam that is disposed along ends of the solar cell modules, and in which the beam has a first base portion on which the ends of the solar cell modules are together placed, a standing portion that stands with respect to the first base portion, and a first hook portion that is bent at an upper end of the standing portion and engages with the ends of the solar cell module, and the ends of the solar cell modules are held between the first hook portion and the first base portion.

In such a solar cell module mounting structure of the present invention, the first base portion, the standing portion, and the first hook portion are provided in the beam itself, the plurality of arrayed solar cell modules are placed on the first base portion, the ends of the solar cell modules are engaged with the first hook portion, and the ends of the solar cell modules are held between the first hook portion and the first base portion. Accordingly, the single beam may couple and support the plurality of solar cell modules. This reduces the numbers of parts and assembling steps.

Further, in the solar cell module mounting structure of the present invention, a first recess that extends along a longitudinal direction of the beam is preferably formed in a part on an upper surface of the first base portion that is separated from the standing portion.

In this case, the ends of the solar cell modules are able to be fixed to and supported by the beam by: disposing the end of the solar cell module in the first recess, inclining the beam with respect to a mounting surface of the beam to make the first hook portion approach the end of the solar cell module, raising the inclined beam, stably placing the beam on the mounting surface, sliding the end of the solar cell module from the first recess toward the standing portion on the first base portion, engaging the end of the solar cell module with the first hook portion, holding the end of the solar cell module between the first hook portion and the first base portion, and thereafter fixing the beam.

In addition, in the solar cell module mounting structure of the present invention, the beam may have a second base portion that is provided on an opposite side from the first base portion with respect to the standing portion and on which ends of the plurality of arrayed solar cell modules are placed and a second hook portion that is bent to an opposite side from the first hook portion at the upper end of the standing portion and engages with the ends of the solar cell modules, and the ends of the solar cell modules may be held between the second hook portion and the second base portion.

Further, in the solar cell module mounting structure of the present invention, a second recess that extends along the longitudinal direction of the beam is preferably formed in a part on an upper surface of the second base portion that is separated from the standing portion.

In this case, arrays formed of the plurality of arrayed solar cell modules are able to be fixed next to each other across the standing portion.

In addition, in the solar cell module mounting structure of the present invention, a linear protrusion that extends in a direction orthogonal to the longitudinal direction of the beam may be formed on an upper surface of the first base portion or an upper surface of the second base portion.

In a case where such a linear protrusion is provided, when the end of the solar cell module is slid on the first base portion or the end of the solar cell module is slid on the second base portion, the linear protrusion is stuck into the end of the solar cell module, the linear protrusion and the end of the solar cell module become a conductive state, and the solar cell module is able to be grounded through the beam, thus grounding work being facilitated. Further, because the linear protrusion is formed in the direction orthogonal to the longitudinal direction of the beam, the linear protrusion is easily stuck into the end of the solar cell module without being caught when the end of the solar cell module is slid on the first base portion or the second base portion.

Next, a solar cell module mounting method of the present invention is a solar cell module mounting method of fixing the solar cell module by using the solar cell module mounting structure of the present invention, in which the end of the solar cell module is disposed in the first recess, the beam is inclined with respect to a mounting surface of the beam to make the first hook portion approach the end of the solar cell module, the inclined beam is raised, the beam is stably placed on the mounting surface, the end of the solar cell module is slid from the first recess toward the standing portion on the first base portion, the end of the solar cell module is engaged with the first hook portion, and the end of the solar cell module is held between the first hook portion and the first base portion.

Such a mounting method of the present invention facilitates solar cell module mounting work.

Next, a solar cell module mounting beam of the present invention is a solar cell module mounting beam that is used in mounting of a solar cell module, which includes: a first base portion that extends in a longitudinal direction of the beam; a standing portion that stands with respect to the first base portion; and a first hook portion that is bent at an upper end of the standing portion, and in which a first recess that extends along the longitudinal direction of the beam is formed in a part on an upper surface of the first base portion that is separated from the standing portion.

Further, in the solar cell module mounting beam of the present invention, the beam preferably has a second base portion that is provided on an opposite side from the first base portion with respect to the standing portion and extends in the longitudinal direction of the beam and a second hook portion that is bent to an opposite side from the first hook portion at the upper end of the standing portion, and a second recess that extends along the longitudinal direction of the beam is preferably formed in a part on an upper surface of the second base portion that is separated from the standing portion.

By using such a solar cell module mounting beam of the present invention, the solar cell module mounting structure and mounting method of the present invention are able to be realized.

Next, in a solar photovoltaic power generating system of the present invention, a plurality of solar cell modules are mounted by using the solar cell module mounting structure of the present invention.

Such a solar photovoltaic power generating system of the present invention may provide similar effects to the solar cell module mounting structure and mounting method of the present invention.

### Advantageous Effects of Invention

In the present invention, the first base portion, the standing portion, the first hook portion, and the first recess on the upper surface of the first base portion are provided in the beam itself. In a case where such a beam is used, the end of each of the solar cell modules is able to be fixed to and supported by the beam by: disposing the end of the solar cell module in the first recess, inclining the beam with respect to the mounting surface of the beam to make the first hook portion approach the end of the solar cell module, raising the inclined beam, stably placing the beam on the mounting surface, sliding the end of the solar cell module from the first recess toward the standing portion on the first base portion, engaging the end of the solar cell module with the first hook portion, holding the end of the solar cell module between the first hook portion and the first base portion, and thereafter fixing the beam. Accordingly, the end of the solar cell module is able to be fixed only by the beam, and it is not necessary to provide a separate metal fastening for fixing the end of the solar cell module on the beam, resulting in the small numbers of parts and assembling steps.

### BRIEF DESCRIPTION OF DRAWINGS

FIG. 1 is a perspective view illustrating a solar photovoltaic power generating system in which a plurality of solar cell modules are supported by using one embodiment of a solar cell module mounting structure of the present invention.

FIG. 2 is a perspective view illustrating the solar cell module in the solar photovoltaic power generating system in FIG. 1.

FIG. 3 is a cross-sectional view illustrating a frame of the solar cell module on larger scale.

FIG. 4 is a perspective view illustrating a metal support of the solar cell module mounting structure according to the embodiment.

FIG. 5 is a perspective view illustrating a lateral beam of the solar cell module mounting structure according to the embodiment.

FIG. 6 is a cross-sectional view illustrating the lateral beam in FIG. 5.

FIGS. 7(a) and 7(b) are a plan view and a cross sectional-view that illustrate linear protrusions of the lateral beam.

FIG. 8 is a perspective view illustrating a metal attachment for attaching the lateral beam to the metal support.

FIG. 9 is an exploded perspective view illustrating a fixing structure of the metal support, the lateral beam, and the metal attachment.

FIG. 10 is a cross-sectional view illustrating a fixing structure of the metal support, the lateral beam, and the metal attachment.

FIG. 11 is a cross-sectional view illustrating a structure in which two solar cell modules are fixed to the lateral beam.

FIGS. 12(a) to 12(d) are views that illustrate a work procedure for holding a long frame of the solar cell module on a downstream side in a water flow direction between a second base portion and a second hook portion of the lateral beam.

FIGS. 13(a) to 13(d) are views that illustrate a work procedure for holding a long frame of the solar cell module on an upstream side in a water flow direction between a first base portion and a first hook portion of the lateral beam.

FIG. 14 is a plan view that schematically illustrates an array of the solar cell modules in the solar photovoltaic power generating system in FIG. 1.

### DESCRIPTION OF EMBODIMENTS

An embodiment of the present invention will hereinafter be described with reference to the attached drawings.

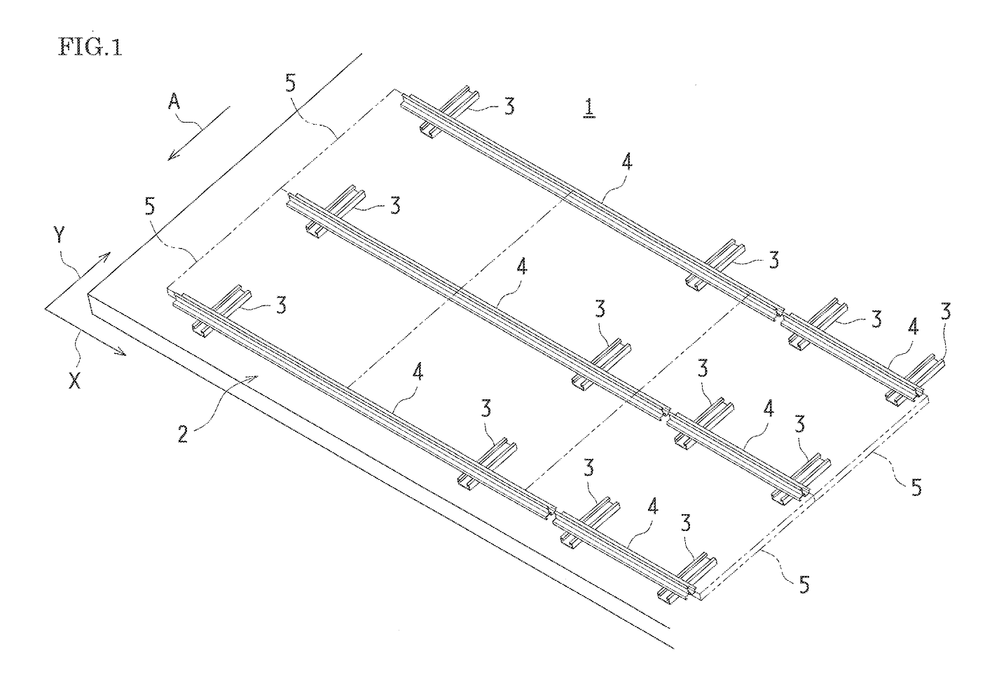

FIG. 1 is a perspective view illustrating a solar photovoltaic power generating system in which a plurality of solar cell modules are supported by using one embodiment of a solar cell module mounting structure of the present invention.

As illustrated in FIG. 1, in this solar photovoltaic power generating system 1, a plurality of metal supports 3 are disposed on and fixed to a roof 2, lateral beams 4 are disposed on and fixed to the metal supports 3 mutually in parallel at regular intervals, and solar cell modules 5 are laid over between the lateral beams 4 and also fixed and supported.

Here, the longitudinal direction of each of the lateral beams 4 corresponds to a direction orthogonal to a water flow direction A. Further, a vertical direction Y is a direction along the water flow direction A on the roof 2, and a horizontal direction X is a direction orthogonal to the water flow direction A.

The lateral beams 4 for first, second, and third lines are arranged from the downstream side to the upstream side in the water flow direction A, three solar cell modules 5 for a first array are laid over and fixed between the lateral beams 4 for the first and second lines, and three solar cell modules 5 for a second array are laid over and fixed between the lateral beams 4 for the second and third lines.

Further, two lateral beams 4 in different lengths are disposed along ends of the three solar cell modules 5 in each of the first to third lines. The long lateral beam 4 is longer than the length of the first and second solar cell modules 5 in the horizontal direction X and holds the entire ends of the first and second solar cell modules 5 and a part of the end of the third solar cell module 5. Further, the short lateral beam 4 is shorter than the length of the single solar cell module 5 in the horizontal direction X and holds the section of the end of the third solar cell module 5 that the long lateral beam 4 does not cover.

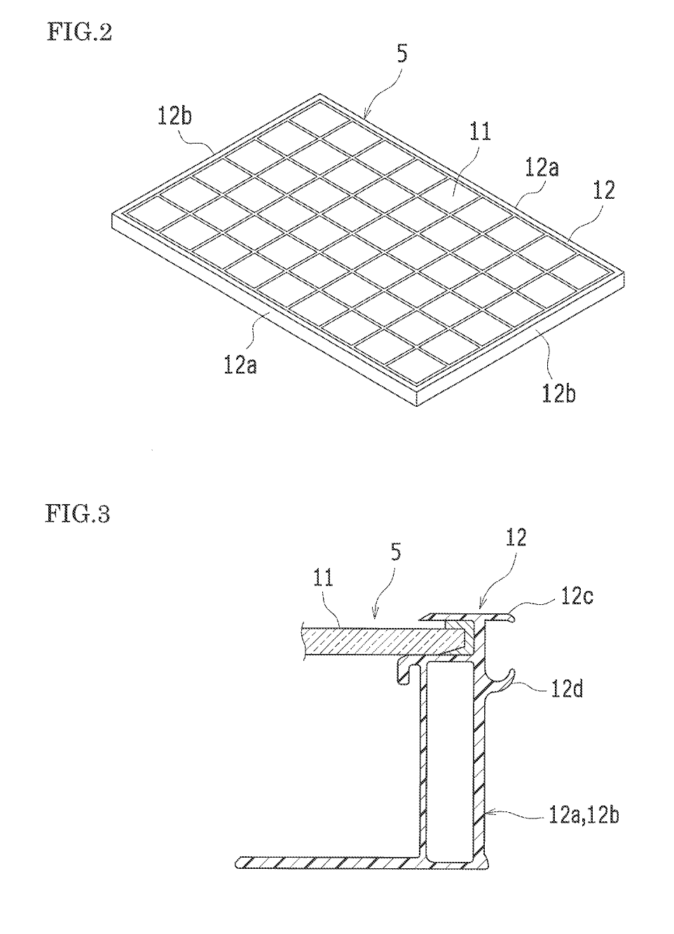

FIG. 2 is a perspective view illustrating the solar cell module 5. As illustrated in FIG. 2, the solar cell module 5 is configured with a photovoltaic panel 11 that performs photoelectric conversion on sunlight and a frame 12 that frames and holds the photovoltaic panel 11. The frame 12 is formed of an aluminum material and assembled from two long frames 12a and two short frames 12b.

The photovoltaic panel 11 is obtained, for example, by forming a photovoltaic cell by sequentially laminating a transparent conducting electrode film formed of a transparent conductive film, a photoelectric conversion layer, and a backside electrode film on a translucent insulating substrate, further laminating a sealing film and a backside protecting layer or the like for securing weathering properties and high insulation on the backside electrode film, and integrating the whole layered structure by laminate sealing.

Glass or heat-resistant resins such as polyimides are employed for the translucent insulating substrate. SnO₂, ZnO, ITO, or the like is employed for the transparent conducting electrode film. A silicon-based photoelectric conversion film formed of amorphous silicon or microcrystalline silicon or a compound photoelectric conversion film formed of CdTe or CuInSe₂ is, for example, employed for the photoelectric conversion layer. A transparent conducting electrode film formed of ZnO, a thin silver film, or the like is employed for the backside electrode film. A thermoplastic high-molecular film is preferable as the sealing film. Particularly, a film formed of ethylene vinyl acetate (EVA) resin or polyvinyl butyral (PVB) resin is more preferable. The backside protecting layer has a three-layer structure of PET/Al/PET (PET: polyethylene terephthalate, Al: aluminum) or a three-layer structure of PVF/Al/PVF (PVF: polyvinyl fluoride resin). Such a structure is employed because only PET or PVF prevent entrance of water drops but does not prevent entrance of water vapor and a metal Al layer is necessary for preventing the entrance of water vapor.

Alternatively, the photovoltaic panel 11 is obtained by the photovoltaic cell formed by sequentially laminating the transparent conducting electrode film, the photoelectric conversion layer, and the backside electrode film and being interposed between two glass plates and sealing ends of the glass plates.

FIG. 3 is a cross-sectional view illustrating the frame 12 (the long frame 12a and the short frame 12b) of the solar cell module 5 on larger scale. As illustrated in FIG. 3, the frame 12 has a plate-like rib 12c that protrudes outward from an upper edge of a side wall and an L-shaped protrusion 12d that protrudes outward from the side wall. An outer end of the L-shaped protrusion 12d is directed upward.

Next, a support structure of the solar cell module will be described. The support structure of the solar cell module in this embodiment is mainly formed of the metal supports 3, the lateral beams 4, and metal attachments that will be described below.

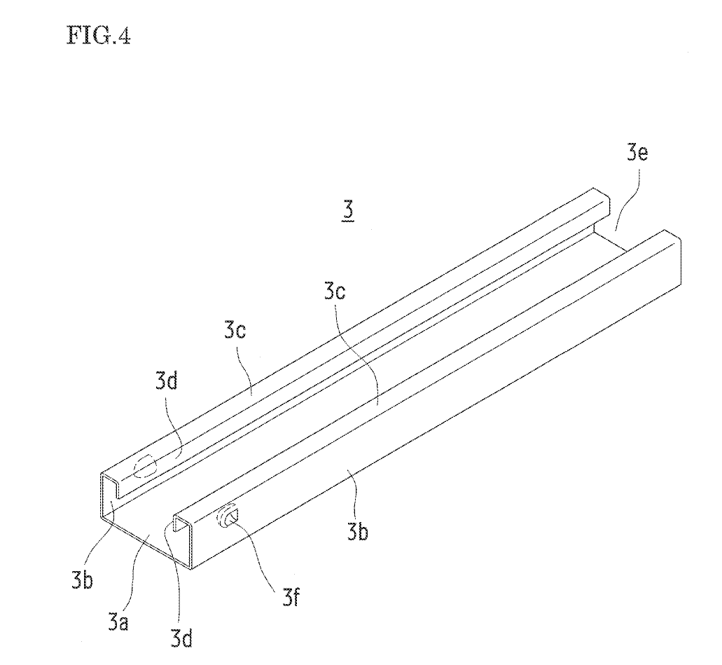

FIG. 4 is a perspective view illustrating the metal support 3. As illustrated in FIG. 4, the metal support 3 has a long-rectangular bottom plate 3a, side walls 3b that are bent upward on both sides of the bottom plate 3a, top plates 3c that are bent inward on upper sides of the respective side walls 3b, and guide walls 3d that are bent downward on inner sides of the respective top plates 3c. A gap is formed between the guide walls 3d, and the gap serves as an opening groove 3e. Further, stoppers 3f are formed in the vicinities of one ends of the respective side walls 3b.

Such a metal support 3 is fixed to the roof 2 by a known method or structure. For example, the metal support 3 may be fixed by a metal fitting that passes through a roofing tile of the roof 2 and is connected to a rafter.

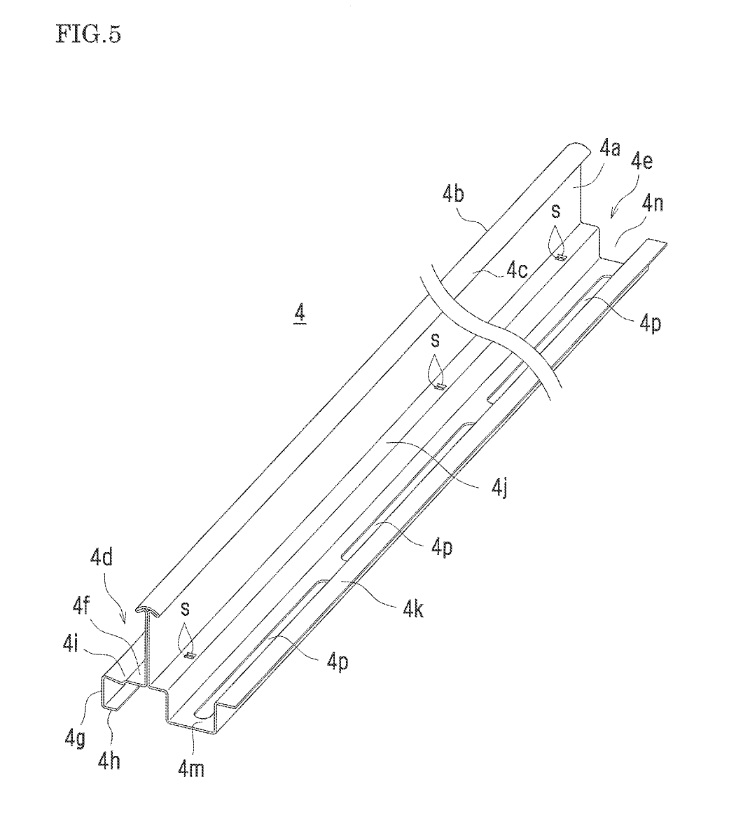

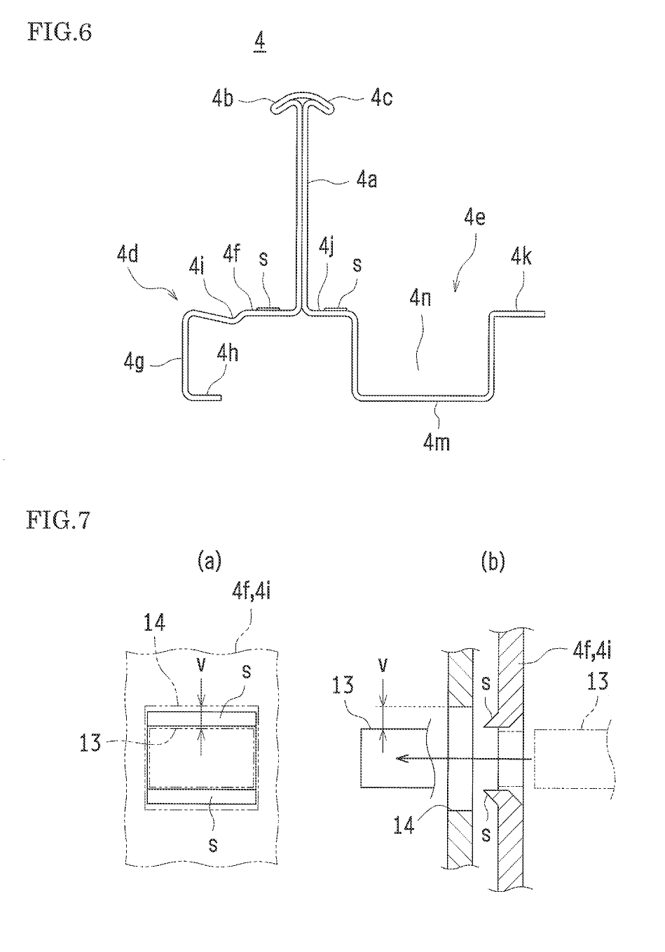

FIGS. 5 and 6 are a perspective view and a cross-sectional view that illustrate the lateral beam 4. As illustrated in FIGS. 5 and 6, the lateral beam 4 is formed by cutting, bending, and plating a single steel plate and has a standing wall portion 4a that is formed by folding and doubling the steel plate in a central section of the lateral beam 4 and a first hook portion 4b and a second hook portion 4c that are bent in the mutually opposite directions and obliquely downward at an upper end of the standing wall portion 4a. Further, a first base portion 4d and a second base portion 4e are provided on both sides of the standing wall portion 4a.

The first base portion 4d has an upper plate 4f on which the long frame 12a of the solar cell module 5 is placed, a side plate 4g, and a bottom plate 4h that is placed on the metal support 3. A first recess portion 4i that extends in the longitudinal direction of the lateral beam 4 is formed in a part of the upper plate 4f that is separated from the standing wall portion 4a. The cross-sectional shape of the first recess portion 4i is an inverted triangle. Further, a plurality of linear protrusions s that protrude upward from the upper plate 4f are formed in parts of the upper plate 4f that are adjacent to the standing wall portion 4a.

The second base portion 4e has upper plates 4j and 4k on which the long frame 12a of the solar cell module 5 is placed and a bottom plate 4m that is placed on the metal support 3. A second recess portion 4n that extends in the longitudinal direction of the lateral beam 4 is formed between the upper plates 4j and 4k (a part separated from the standing wall portion 4a). The cross-sectional shape of the second recess portion 4n is a rectangle. A lower side of the second recess portion 4n forms the bottom plate 4m. Further, long holes 4p are formed in the bottom plate 4m. Further, a plurality of linear protrusions s that protrude upward from the upper plate 4j are formed in the upper plate 4j.

As illustrated in FIG. 6, the height from the bottom plate 4h to the upper plate 4f of the first base portion 4d is the same as the height from the bottom plate 4m to the upper plate 4j of the second base portion 4e. When the bottom plate 4h of the first base portion 4d and the bottom plate 4m of the second base portion 4e are placed on the metal supports 3, the upper plate 4f of the first base portion 4d and the upper plate 4j of the second base portion 4e are at the same height as and in parallel with the top plates 3c of the metal supports 3.

As illustrated in FIGS. 5 and 6, the linear protrusions s protrude upward from the upper plates 4f and 4j and extend in the direction orthogonal to the longitudinal direction of the lateral beam 4. The cross-sectional shapes of the linear protrusions s as illustrated in FIGS. 7(a) and 7(b) are formed when rectangular holes are formed by punching in a steel plate by a rectangular punch 13 and a die 14. The linear protrusions s are formed by enlarging burrs that are generated in punching by intentionally enlarging a clearance v that extends in the orthogonal direction between the punch 13 and the die 14.

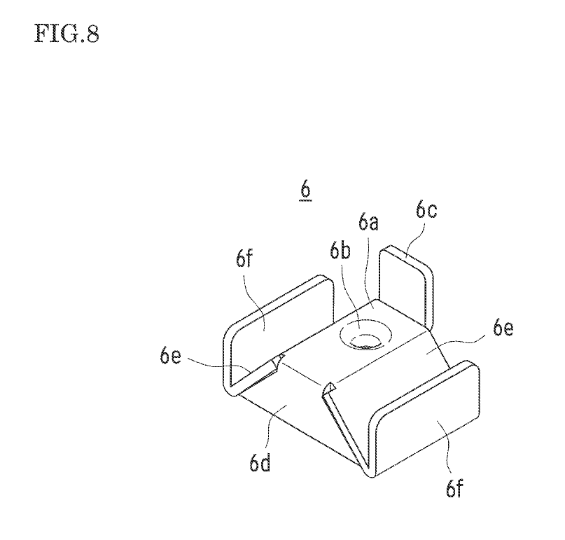

FIG. 8 is a perspective view illustrating a metal attachment 6 for attaching the lateral beam 4 to the metal support 3. As illustrated in FIG. 8, the metal attachment 6 is formed of a single steel plate that is cut, bent, and plated and has a main plate 6a, a protrusion segment 6c that is bent upward at a front end of the main plate 6a, a triangular reinforcement segment 6d that is bent downward at a rear end of the main plate 6a, inclined plates 6e that are bent obliquely downward at both ends of the main plate 6a, and slide plates 6f that are bent upward at outer ends of the inclined plates 6e. A screw hole 6b is formed in a central section of the main plate 6a. Further, the triangular reinforcement segment 6d is fitted into lower sides of the inclined plates 6e and reinforces the inclined plates 6e.

The gap between the slide plates 6f is set wider than the gap between the guide walls 3d of the metal support 3 and narrower than the gap between the side walls 3b, and the heights of the slide plates 6f are set higher than the height from the bottom plate 3a to lower ends of the guide walls 3d of the metal support 3 and lower than the height from the bottom plate 3a to the top plate 3c. This allows the metal attachment 6 to be inserted in the inside of the metal support 3 by inserting the slide plates 6f between the side walls 3b and the respective guide walls 3d of the metal support 3.

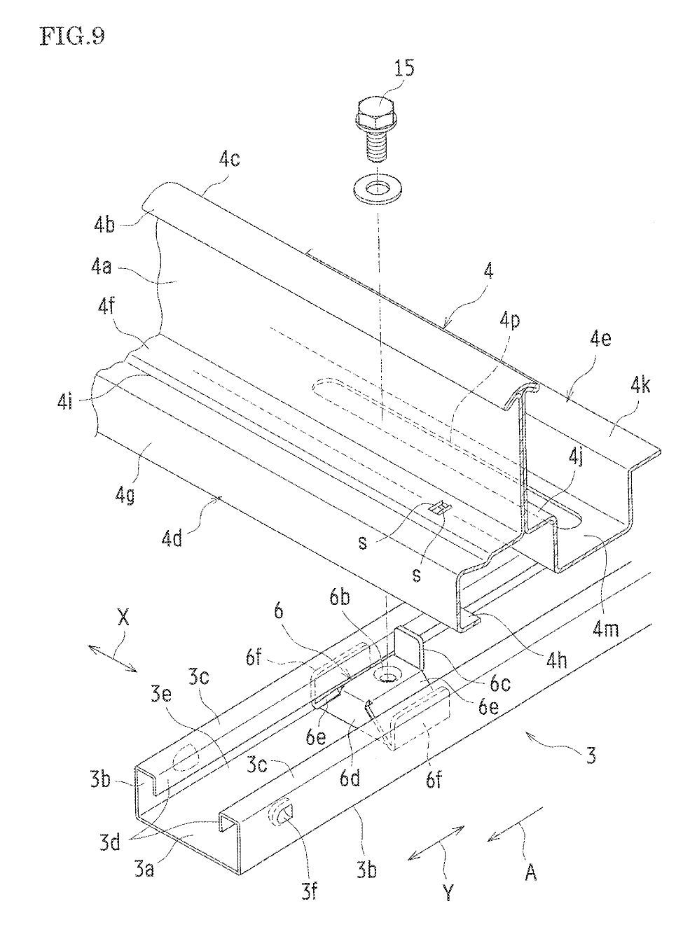

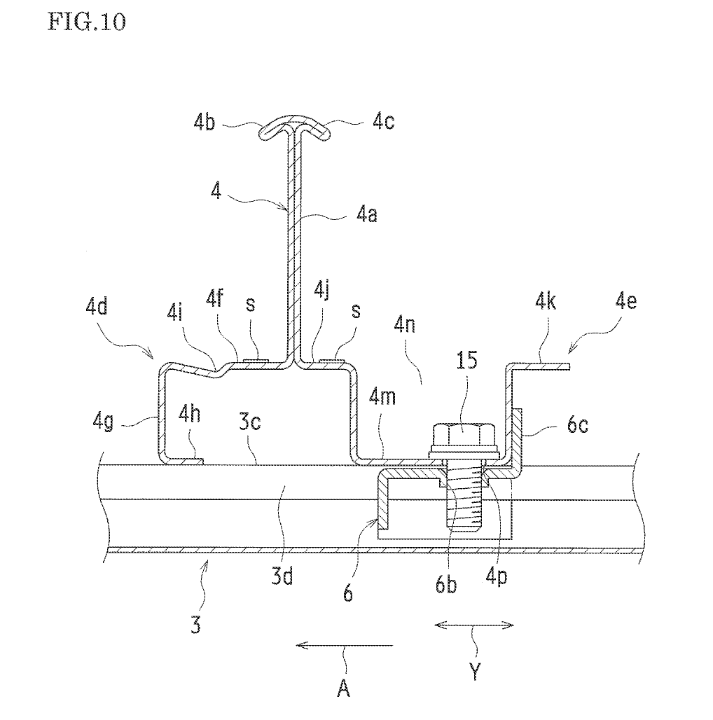

FIG. 9 is an exploded perspective view illustrating a fixing structure of the metal support 3, the lateral beam 4, and the metal attachment 6. FIG. 10 is a cross-sectional view illustrating the fixing structure of the metal support 3, the lateral beam 4, and the metal attachment 6.

Here, as described above, the metal support 3 is fixed to the roof 2 by an appropriate method or structure. Then, as illustrated in FIG. 9, the orientation of the metal support 3 is set such that the opening groove 3e of the metal support 3 is along the water flow direction A and the stoppers 3f of the metal support 3 are positioned on the downstream side in the water flow direction A.

Next, the lateral beam 4 is placed on the top plates 3c of the metal support 3. The metal attachment 6 is inserted in the inside of the metal support 3 from the upstream side in the water flow direction A, and the metal attachment 6 is moved to the downstream side in the water flow direction A. The protrusion segment 6c of the metal attachment 6 is brought into contact with one end of the bottom plate 4m of the lateral beam 4, and the main plate 6a of the metal attachment 6 is disposed on the bottom plate 4m of the lateral beam 4 in an overlapping manner.

Thereafter, a bolt 15 is made pass through a washer, and the bolt 15 is screwed into the screw hole 6b of the main plate 6a of the metal attachment 6 via the long hole 4p in the bottom plate 4m of the lateral beam 4. The top plates 3c of the metal support 3 are thereby interposed between the slide plates 6f of the metal attachment 6 and the bottom plate 4m of the lateral beam 4, and the bottom plate 4m of the lateral beam 4 is temporarily attached on the top plates 3c of the metal support 3. In the temporarily attached state, the lateral beam 4 and the metal attachment 6 are able to be moved (in the Y direction) along the opening groove 3e of the metal support 3, the lateral beam 4 is able to be moved in the longitudinal direction (in the X direction) of the long hole 4p of the bottom plate 4m of the lateral beam 4, and the lateral beam 4 is able to be positioned by being moved in the X and Y directions. The bolt 15 is thereafter tightened to fix the lateral beam 4 and the metal attachment 6 to the metal support 3.

FIG. 11 is a cross-sectional view illustrating a structure in which two solar cell modules 5 placed across the lateral beam 4 are fixed to the lateral beam 4.

As illustrated in FIG. 11, the long frame 12a of one of the solar cell modules 5 is placed on the first base portion 4d of the lateral beam 4, the outer end of the L-shaped protrusion 12d of the long frame 12a is pushed into a lower side of the first hook portion 4b of the lateral beam 4, the L-shaped protrusion 12d of the long frame 12a is caught by and engages with the first hook portion 4b, and the long frame 12a is held between the first base portion 4d and the first hook portion 4b.

Further, the long frame 12a of the other solar cell module 5 is placed on the second base portion 4e of the lateral beam 4, the outer end of the L-shaped protrusion 12d of the long frame 12a is pushed into a lower side of the second hook portion 4c of the lateral beam 4, the L-shaped protrusion 12d of the long frame 12a is caught by and engages with the second hook portion 4c, and the long frame 12a is held between the second base portion 4e and the second hook portion 4c.

Accordingly, the long frame 12a of the one solar cell module 5 is held between the first base portion 4d and the first hook portion 4b of the lateral beam 4, the long frame 12a of the other solar cell module 5 is held between the second base portion 4e and the second hook portion 4c, and the long frames 12a of the respective solar cell modules are fixed next to each other across the lateral beam 4. In FIG. 1, the upper and lower long frames 12a of each of the solar cell modules 5 are held by the lateral beams 4.

Next, a description will be made about construction procedures for attaching the solar cell modules 5 on the roof 2 by using the solar cell module mounting structure of this embodiment.

First, as illustrated in FIG. 1, disposing positions of the lateral beams 4 on the roof 2 are determined in accordance with disposing positions of the solar cell modules 5, disposing positions of the metal supports 3 are determined in accordance with the disposing positions of the lateral beams 4, and the metal supports 3 are fixed. Then, the long lateral beam 4 and the short lateral beam 4 for the first line are disposed in line on the metal supports 3, and the lateral beams 4 for the first line are fixed on the top plates 3c of the metal supports 3 by using the metal attachments 6 and the bolts 15 as illustrated in FIGS. 9 and 10. Here, the lateral beams 4 for the first line are fixed such that the second hook portions 4c and the second base portions 4e of the lateral beams 4 for the first line are directed to the upstream side in the water flow direction A.

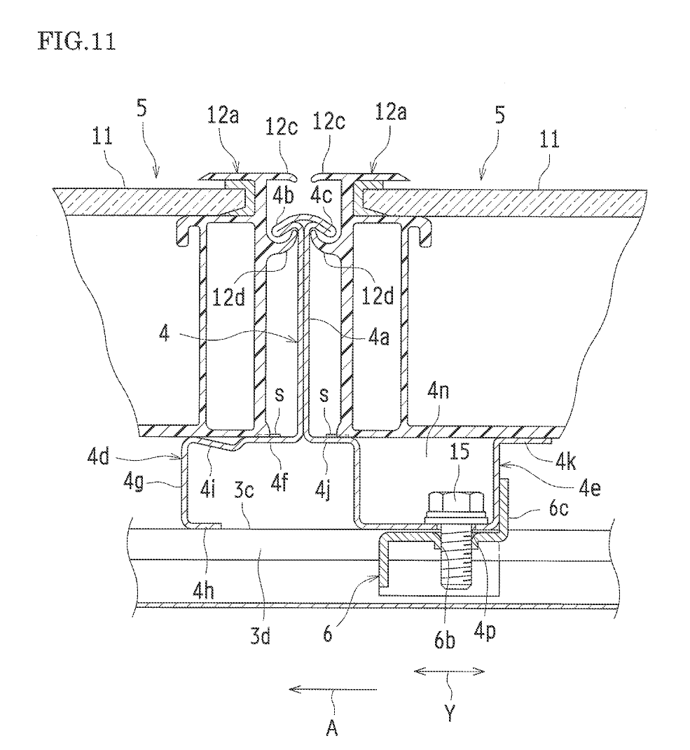

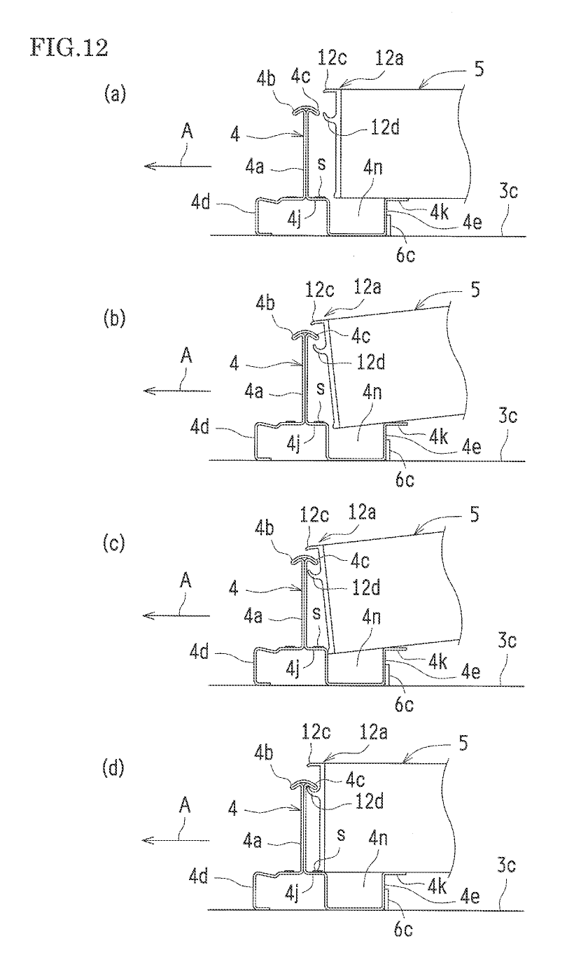

Thereafter, for each of the three solar cell modules 5 for the first array, the long frame 12a of the solar cell module 5 on the downstream side in the water flow direction A is placed on the upper plate 4k of the second base portion 4e of the lateral beam 4 for the first line as illustrated in FIG. 12(a). As illustrated in FIG. 12(b), one side of the solar cell module 5 on the upstream side in the water flow direction A is brought up to incline the solar cell module 5. A lower corner section of the long frame 12a of the solar cell module 5 is inserted in the second recess portion 4n of the lateral beam 4 for the first line, and the L-shaped protrusion 12d of the long frame 12a is pushed into a section below the second hook portion 4c of the lateral beam 4 for the first line. As illustrated in FIG. 12(c), the long frame 12a of the solar cell module 5 is slid from the second recess portion 4n toward the standing wall portion 4a and placed on the upper plate 4j. As illustrated in FIG. 12(d), the one side of the solar cell module 5 on the upstream side in the water flow direction A is brought down, and the L-shaped protrusion 12d of the long frame 12a of the solar cell module 5 is engaged with the second hook portion 4c of the lateral beam 4. Thus, the long frame 12a of the solar cell module 5 for the first array on the downstream side in the water flow direction A is held between the second base portion 4e and the second hook portion 4c of the lateral beam 4 for the first line. Further, the long frame 12a is pressed to the linear protrusions s of the upper plate 4j by the sliding of the long frame 12a on the upper plate 4j of the lateral beam 4, and the linear protrusions s are stuck into the long frame 12a of the solar cell module 5. Here, because the linear protrusions s extend in the direction orthogonal to the longitudinal direction of the lateral beam 4 (the moving direction of the long frame 12a), the linear protrusions s are easily stuck into the long frame 12a of the solar cell module 5 without being caught. This makes the solar cell modules 5 for the first array and the lateral beams 4 for the first line electrically conductive with each other.

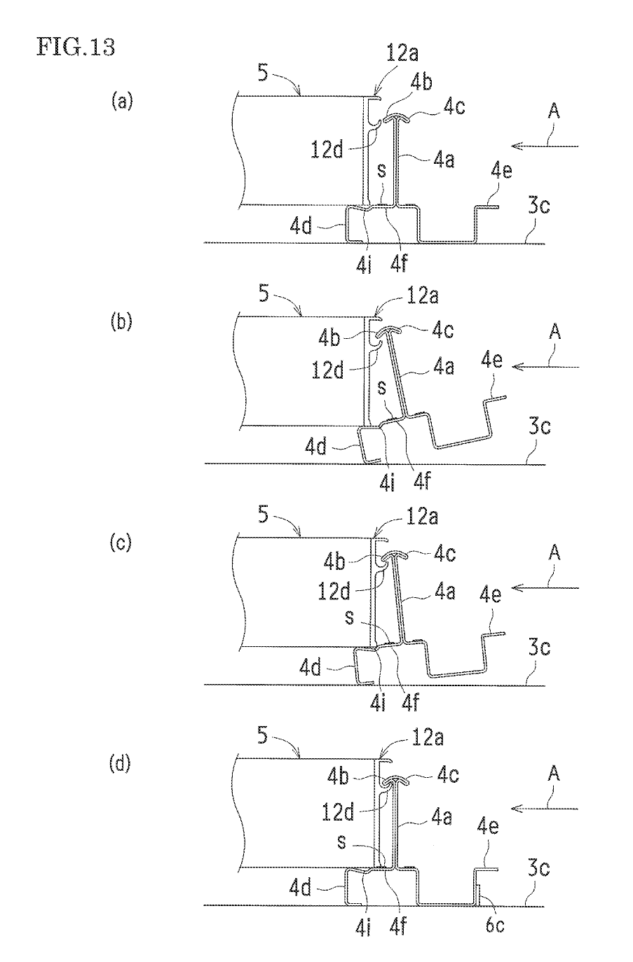

Next, the long lateral beam 4 and the short lateral beam 4 for the second line are disposed in line on the metal supports 3, and the lateral beams 4 for the second line are placed on the top plates 3c of the metal supports 3. Then, as illustrated in FIG. 13(a), the long frame 12a of each of the solar cell modules 5 for the first array on the upstream side in the water flow direction A is brought up, the lateral beam 4 for the second line is slid on the top plates 3c of the metal supports 3, and the lower corner section of the long frame 12a of the solar cell module 5 for the first array is placed on the first recess portion 4i of the first base portion 4d of the lateral beam 4 for the second line. Further, as illustrated in FIG. 13(b), the lateral beam 4 for the second line is inclined with respect to upper surfaces of the top plates 3c of the metal support 3, the first hook portion 4b of the lateral beam 4 is made approach the side wall of the long frame 12a of the solar cell module 5, and the L-shaped protrusion 12d of the long frame 12a of the solar cell module 5 is pushed into a section below the first hook portion 4b of the lateral beam 4. As illustrated in FIG. 13(c), the lateral beam 4 for the second line is raised on the top plates 3c of the metal support 3, and the long frame 12a of the solar cell module 5 is slid from the first recess portion 4i toward the standing wall portion 4a on the upper plate 4f. As illustrated in FIG. 13(d), the lateral beam 4 for the second line is stably placed on the top plates 3c of the metal support 3, a side wall surface of the long frame 12a of the solar cell module 5 is made face the standing wall portion 4a of the lateral beam 4, and the L-shaped protrusion 12d of the long frame 12a is engaged with the first hook portion 4b of the lateral beam 4. Thus, the long frame 12a of the solar cell module 5 for the first array on the upstream side in the water flow direction A is held between the first base portion 4d and the first hook portion 4b of the lateral beam 4 for the second line. Further, the long frame 12a of the solar cell module 5 is pressed to the linear protrusions s of the upper plate 4f by the movement of the long frame 12a on the upper plate 4f of the lateral beam 4, and the linear protrusions s are stuck into the long frame 12a of the solar cell module 5. Here, because the linear protrusions s extend in the direction orthogonal to the longitudinal direction of the lateral beam 4 (the moving direction of the long frame 12a), the linear protrusions s are easily stuck into the long frame 12a of the solar cell module 5 without being caught. This makes the solar cell modules 5 for the first array and the lateral beams 4 electrically conductive with each other.

Thereafter, the metal attachment 6 is inserted in the inside of the metal support 3 from the upstream side in the water flow direction A, and the metal attachment 6 is moved to the downstream side in the water flow direction A. The protrusion segment 6c of the metal attachment 6 is brought into contact with one end of the bottom plate 4m of the lateral beam 4, and the main plate 6a of the metal attachment 6 is disposed on the bottom plate 4m of the lateral beam 4 in an overlapping manner. Then, the lateral beams 4 for the second line are fixed to the metal supports 3 by using the metal attachments 6 and the bolts 15 as illustrated in FIGS. 9 and 10.

Subsequently, the procedure illustrated in FIGS. 12(a) to 12(d) is performed in a similar manner. The long frames 12a of solar cell modules 5 for the second array on the downstream side in the water flow direction A are held between the second base portions 4e and the second hook portions 4c of the lateral beams 4 for the second line, and the linear protrusions s of the upper plates 4j of the lateral beams 4 are stuck into the long frames 12a of the solar cell modules 5 to obtain electric conduction. Further, by the procedure illustrated in FIGS. 13(a) to 13(d), the long frames 12a of the solar cell modules 5 for the second array on the upstream side in the water flow direction A are held between the first base portions 4d and the first hook portions 4b of the lateral beams 4 for the third line, and the linear protrusions s of the upper plates 4f are stuck into the long frames 12a of the solar cell modules 5 to obtain electric conduction.

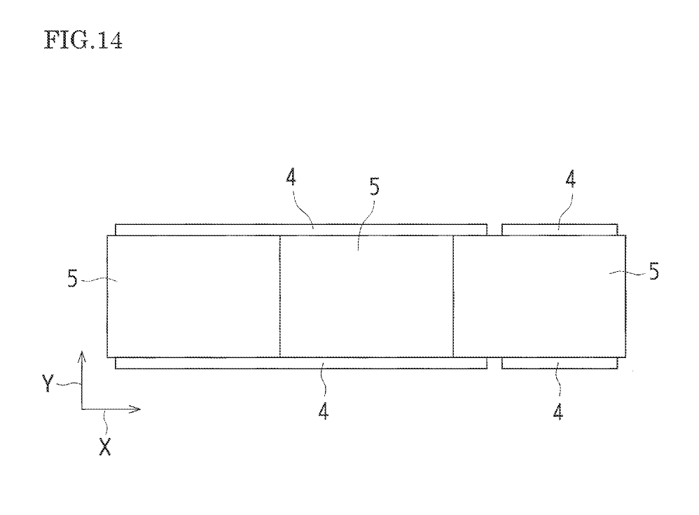

FIG. 14 is a plan view illustrating the array of the solar cell modules 5 in the solar photovoltaic power generating system 1 that is assembled in such procedures. As illustrated in FIG. 14, the long lateral beam 4 is longer than the length of the first and second solar cell modules 5 in the horizontal direction X and holds the entire ends of the first and second solar cell modules 5 and a part of the end of the third solar cell module 5. Accordingly, the three solar cell modules 5 are coupled to the long lateral beam 4. Thus, a separate coupling member for coupling the solar cell modules 5 is not necessary, a bent alignment of the solar cell modules 5 may be prevented, and the lateral beams 4 and the frames 12 of the solar cell modules 5 synergetically enhance rigidity and strength of the support structure. In addition, because the long frames 12a of the solar cell modules 5 are fixed to and supported by the lateral beams 4 and at the same time the linear protrusions s of the lateral beams 4 are stuck into the long frames 12a of the solar cell modules 5 to obtain electric conduction, all the solar cell modules 5 of the solar photovoltaic power generating system 1 are grounded through the lateral beams 4, thus facilitating grounding work.

As described above, in the solar photovoltaic power generating system 1 of this embodiment, the first and second base portions 4d, 4e, the standing wall portion 4a, the first and second hook portions 4b, 4c, and the first and second recess portion 4i, 4n are provided to the lateral beam 4 itself. Thus, the frame 12 of the solar cell module 5 may be fixed to the lateral beam 4 by the simple procedures illustrated in FIGS. 12(a) to 12(d) and FIGS. 13(a) to 13(d), and the plurality of solar cell modules 5 are coupled and supported by the single lateral beam 4. This reduces the numbers of parts of the support structure and of assembling steps.

Further, because the cross-sectional shape of the first recess portion 4i is an inverted triangle, the frame 12 of the solar cell module 5 is stably placed on one side of the inverted triangle, and the frame 12 of the solar cell module 5 may easily be slid from the first recess portion 4i toward the standing wall portion 4a.

In addition, the two solar cell modules 5 are fixed next to each other across the standing wall portion 4a, and a space between the solar cell modules 5 that does not contribute to photovoltaic power generation may be minimized.

A preferable embodiment of the present invention has been described with reference to the attached drawings in the foregoing. However, it should be noted that the present invention is not limited to such an embodiment. It is clear that a person skilled in the art may conceive various variations and modifications within the scope described in claims and it is matter of course that those belong to the technical scope of the present invention.

### INDUSTRIAL APPLICABILITY

The present invention relates to a solar cell module mounting structure, a solar cell module mounting method, solar cell module mounting beam, and a solar photovoltaic power generating system that are preferable for mounting a solar cell module on a roof or the like.

This application claims priority from Japanese Patent Application No. 2012-021193 filed on Feb. 2, 2012, the entire contents of which are incorporated herein by reference.

### REFERENCE SIGNS LIST

1 solar photovoltaic power generating system
2 roof
3 metal support
4 lateral beam (beam)
4a standing wall portion (standing portion)
4b first hook portion
4c second hook portion
4d first base portion
4e second base portion
4i first recess portion (first recess)
4n second recess portion (second recess)
5 solar cell module
6 metal attachment
11 photovoltaic panel
12 frame
s linear protrusion

1. A solar cell module mounting structure comprising:
a beam that is disposed along an end of the solar cell module, wherein
the beam has a first base portion on which the end of the solar cell module is placed, a standing portion that stands with respect to the first base portion, and a first hook portion that is provided in the standing portion and engages with the end of the solar cell module, and
a first recess that extends along a longitudinal direction of the beam is provided in a part on an upper surface of the first base portion that is separated from the standing portion.

2. The solar cell module mounting structure according to claim 1, wherein
a cross-sectional shape of the first recess is an inverted triangle.

3. The solar cell module mounting structure according to claim 1, wherein
an engagement portion that engages with the first hook portion is provided at the end of the solar cell module.

4. The solar cell module mounting structure according to claim 1, wherein
the beam has a second base portion that is provided on an opposite side from the first base portion with respect to the standing portion and on which an end of the solar cell module is placed and a second hook portion that is provided on an opposite side of the standing portion from the first hook portion and engages with the end of the solar cell module, and
a second recess that extends along the longitudinal direction of the beam is provided in a part on an upper surface of the second base portion that is separated from the standing portion.

5. A solar cell module mounting structure that couples and supports a plurality of arrayed solar cell modules, the solar cell module mounting structure comprising:
a beam that is disposed along ends of the solar cell modules, wherein
the beam has a first base portion on which the ends of the solar cell modules are together placed, a standing portion that stands with respect to the first base portion, and a first hook portion that is provided in the standing portion and engages with the ends of the solar cell module, and
the ends of the solar cell modules are held between the first hook portion and the first base portion.

6. The solar cell module mounting structure according to claim 5, wherein
a first recess that extends along a longitudinal direction of the beam is in a part on an upper surface of the first base portion that is separated from the standing portion.

7. The solar cell module mounting structure according to claim 5, wherein
the beam has a second base portion that is provided on an opposite side from the first base portion with respect to the standing portion and on which ends of the plurality of arrayed solar cell modules are placed and a second hook portion that is provided on an opposite side of the standing portion from the first hook portion and engages with the ends of the solar cell modules, and
the ends of the solar cell modules are held between the second hook portion and the second base portion.

8. The solar cell module mounting structure according to claim 7, wherein
a second recess that extends along the longitudinal direction of the beam is provided in a part on an upper surface of the second base portion that is separated from the standing portion.

9. The solar cell module mounting structure according to claim 1, wherein
a linear protrusion that extends in a direction orthogonal to the longitudinal direction of the beam is provided on an upper surface of the first base portion or an upper surface of the second base portion.

10. A solar cell module mounting method of fixing the solar cell module by using the solar cell module mounting structure according to claim 1, the method comprising:
disposing the end of the solar cell module in the first recess,
inclining the beam with respect to a mounting surface of the beam to make the first hook portion approach the end of the solar cell module, and
raising the inclined beam, stably placing the beam on the mounting surface, sliding the end of the solar cell module from the first recess toward the standing portion on the first base portion, engaging the end of the solar cell module with the first hook portion, and holding the end of the solar cell module between the first hook portion and the first base portion.

11. A solar cell module mounting beam that is used in mounting of a solar cell module, the beam comprising:
a first base portion that extends in a longitudinal direction of the beam, a standing portion that stands with respect to the first base portion, and a first hook portion that is provided in the standing portion, wherein
a first recess that extends along the longitudinal direction of the beam is provided in a part on an upper surface of the first base portion that is separated from the standing portion.

12. The solar cell module mounting beam according to claim 11, further comprising:
a second base portion that is provided on an opposite side from the first base portion with respect to the standing portion and extends in the longitudinal direction of the beam and a second hook portion that is provided on an opposite side of the standing portion from the first hook portion, wherein
a second recess that extends along the longitudinal direction of the beam is provided in a part on an upper surface of the second base portion that is separated from the standing portion.

13. A solar photovoltaic power generating system, wherein a plurality of solar cell modules are mounted by using the solar cell module mounting structure according to claim 1.

14. The solar cell module mounting structure according to claim 5, wherein
a linear protrusion that extends in a direction orthogonal to the longitudinal direction of the beam is provided on an upper surface of the first base portion or an upper surface of the second base portion.

15. A solar photovoltaic power generating system, wherein a plurality of solar cell modules are mounted by using the solar cell module mounting structure according to claim 5.
